(19) United States
(12) Patent Application Publication
(10) Pub. No.: US 2005/0251444 A1
(43) Pub. Date: Nov. 10, 2005

(54) Facilitating the serving of ads having different treatments and/or characteristics, such as text ads and image ads

(76) Inventors: Hal Varian, Lafayette, CA (US); Wesley Chan, Mountain View, CA (US); Deepak Jindal, Mountain View, CA (US); Rama Ranganath, Mountain View, CA (US); Amit Patel, Cupertino, CA (US)

Correspondence Address: STRAUB & POKOTYLO, 620 TINTON AVENUE, BLDG. B, 2ND FLOOR, TINTON FALLS, NJ, 07724, US

(21) Appl. No.: 10/842,643

(22) Filed: May 10, 2004

(51) Int. Cl. G06F 17/60

(52) U.S. Cl. 705/14

(57) ABSTRACT

The serving of ads of different ad types, such as text ads and image ads, competing to be rendered on an ad area of a document may be arbitrated by (a) determining candidate ads to serve in response to an ad request, wherein the candidate ads include at least one ad of a first ad type and at least one ad of a second ad type, (b) determining a score of each of at least some of the candidate ads, (c) comparing alternative sets of the at least some of the candidate ads to select a set that best meets at least one policy goal, and (d) serving the selected set of candidate ads. Performance parameter values of ads of one type, such as image ads for example, may be estimated from performance parameter values of ads of a second type, such as text ads for example.

### § 1. BACKGROUND OF THE INVENTION

§ 1.1 Field of the Invention

The present invention concerns advertisements (“ads”), such as ads served in an online environment. In particular, the present invention concerns supporting the serving of ads having different treatments and/or characteristics, such as text ads and image ads for example.

§ 1.2 Background Information

Advertising using traditional media, such as television, radio, newspapers and magazines, is well known. Unfortunately, even when armed with demographic studies and entirely reasonable assumptions about the typical audience of various media outlets, advertisers recognize that much of their ad budget is simply wasted. Moreover, it is very difficult to identify and eliminate such waste.

Recently, advertising over more interactive media has become popular. For example, as the number of people using the Internet has exploded, advertisers have come to appreciate media and services offered over the Internet as a potentially powerful way to advertise.

Interactive advertising provides opportunities for advertisers to target their ads to a receptive audience. That is, targeted ads are more likely to be useful to end users since the ads may be relevant to a need inferred from some user activity (e.g., relevant to a user's search query to a search engine, relevant to content in a document requested by the user, etc.) Query keyword relevant advertising, such as the AdWords advertising system by Google of Mountain View, Calif., has been used by search engines. Similarly, content-relevant advertising systems have been proposed. For example, U.S. patent application Ser. No. 10/314,427 (incorporated herein by reference and referred to as “the '427 application”) titled “METHODS AND APPARATUS FOR SERVING RELEVANT ADVERTISEMENTS”, filed on Dec. 6, 2002 and listing Jeffrey A. Dean, Georges R. Harik and Paul Buchheit as inventors; and Ser. No. 10/375,900 (incorporated by reference and referred to as “the '900 application”) titled “SERVING ADVERTISEMENTS BASED ON CONTENT,” filed on Feb. 26, 2003 and listing Darrell Anderson, Paul Buchheit, Alex Carobus, Claire Cui, Jeffrey A. Dean, Georges R. Harik, Deepak Jindal and Narayanan Shivakumar as inventors, describe methods and apparatus for serving ads relevant to the content of a document, such as a Web page for example.

Targeted ads have often been presented as text ads. However, online ads may include one or more of images, video, animation, audio, etc. to be rendered to an end user.

Although image ads, such as so-called “banner ads” for example, have been used for brand building, it may be useful to use image ads for targeted advertising. Thus, it may be useful to serve ads having different treatments and/or characteristics, such as text ads and image ads for example. Such ads may be targeted ads for example.

Current systems for serving targeted text ads may include means and techniques for scoring ads and for assessing costs to be billed. It would be useful to expand these systems to allow them to accommodate other types of ads. It would be useful if such systems provided a fair competition for competing ads of different types. It would be useful if such systems improved revenue generated from advertisers. It would be useful if such systems provided ads useful to end users. It would be useful to allow a content owner (e.g., a Web page publisher) to have some control over the total size, type, type mix, and/or content of ads to be rendered on its document. Thus, it would be useful to have an improved advertising system for facilitating the serving of ads having different treatments and/or characteristics, such as text ads and image ads for example.

### § 2. SUMMARY OF THE INVENTION

At least some embodiments consistent with the present invention may be used to arbitrate the serving of ads of different ad types, such as text ads and image ads, competing to be rendered on an ad area of a document. For example, at least some embodiments consistent with the present invention may (a) determine candidate ads to serve in response to an ad request, wherein the candidate ads include at least one ad of a first ad type and at least one ad of a second ad type, (b) determine a score of each of at least some of the candidate ads, (c) compare alternative sets of the at least some of the candidate ads to select a set that best meets at least one policy goal, and (d) serve the selected set of candidate ads.

At least some embodiments consistent with the present invention may also be used to estimate performance parameter values of ads of one type, such as image ads for example, from performance parameter values of ads of a second type, such as text ads for example.

At least some embodiments consistent with the present invention may also be used to determine costs to assess to advertisers whose ads are served. For example, at least some embodiments consistent with the present invention may determine the cost to assess to N ads of a second type, such as image ads for example, using information about M ads of a first type, such as text ads for example, displaced by the N ads of the first type, where N is at least one, and M>N. Conversely, at least some embodiments consistent with the present invention may determine the cost to assess to M ads of the first type, such as text ads for example, using information about N ads of a second type, such as image ads for example, displaced by the M ads of the first type.

### § 3. BRIEF DESCRIPTION OF THE DRAWINGS

FIG. 1 is a high-level diagram showing parties or entities that can interact with an advertising system.

FIG. 2 is a diagram illustrating an environment in which, or with which, embodiments consistent with the present invention may operate.

FIG. 3 is a bubble diagram of an ad system in which, or with which, embodiments consistent with the present invention may operate.

FIG. 4 is an exemplary data structure for storing ad information in a manner consistent with the present invention.

FIG. 5 is an exemplary data structure for storing ad request information in a manner consistent with the present invention.

FIG. 6 is an exemplary data structure for storing content owner information in a manner consistent with the present invention.

FIG. 7 is an exemplary data structure for storing usage and/or performance information in a manner consistent with the present invention.

FIG. 8 is a flow diagram of an exemplary method for performing an ad selection operation in a manner consistent with the present invention.

FIG. 9 is a flow diagram of an exemplary method for performing a discounted cost determination operation in a manner consistent with the present invention.

FIG. 10 is a block diagram of an exemplary apparatus that may perform various operations and store various information in a manner consistent with the present invention.

FIGS. 11-13 illustrate examples of operations of an exemplary embodiment of the present invention.

### § 4. DETAILED DESCRIPTION

The present invention may involve novel methods, apparatus, message formats, and/or data structures for helping to serve ads having different treatments and/or characteristics, such as text ads and image ads for example. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. For example, although a series of acts may be described with reference to a flow diagram, the order of acts may differ in other implementations when the performance of one act is not dependent on the completion of another act. Further, non-dependent acts may be performed in parallel. No element, act or instruction used in the description should be construed as critical or essential to the present invention unless explicitly described as such. Also, as used herein, the article “a” is intended to include one or more items. Where only one item is intended, the term “one” or similar language is used. Thus, the present invention is not intended to be limited to the embodiments shown and the inventors regard their invention as any patentable subject matter described.

In the following, environments in which, or with which, the present invention may operate are described in § 4.1. Then, exemplary embodiments consistent with the present invention are described in § 4.2. Examples of operations are provided in § 4.3. Finally, some conclusions regarding the present invention are set forth in § 4.4.

§ 4.1 Environments in which, or with which, the Present Invention may Operate

§ 4.1.1 Exemplary Advertising Environment

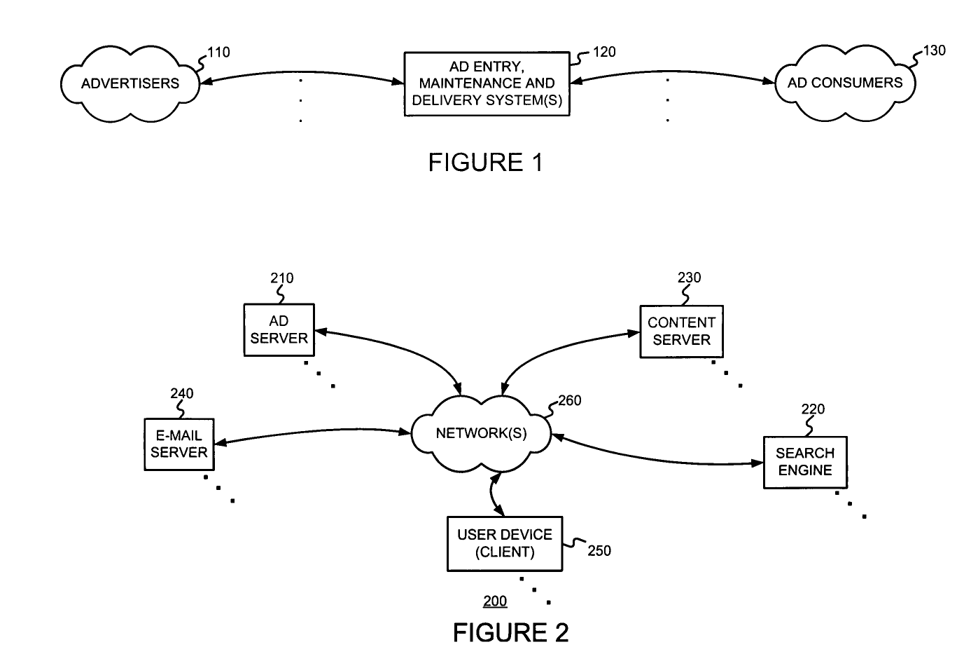

FIG. 1 is a high level diagram of an advertising environment. The environment may include an ad entry, maintenance and delivery system (simply referred to as an ad server) 120. Advertisers 110 may directly, or indirectly, enter, maintain, and track ad information in the system 120. The ads may be in the form of graphical ads such as so-called banner ads, text only ads, image ads, audio ads, animation ads, video ads, ads combining one of more of any of such components, etc. The ads may also include embedded information, such as a link, and/or machine executable instructions. Ad consumers 130 may submit requests for ads to, accept ads responsive to their request from, and provide usage information to, the system 120. An entity other than an ad consumer 130 may initiate a request for ads. Although not shown, other entities may provide usage information (e.g., whether or not a conversion or click-through related to the ad occurred) to the system 120. This usage information may include measured or observed user behavior related to ads that have been served.

The ad server 120 may be similar to the one described in FIG. 2 of U.S. patent application Ser. No. 10/375,900 (incorporated herein by reference), entitled “SERVING ADVERTISEMENTS BASED ON CONTENT,” filed on Feb. 26, 2003 and listing Darrell Anderson, Paul Bucheit, Alex Carobus, Claire Cui, Jeffrey A. Dean, Georges R. Harik, Deepak Jindal, and Narayanan Shivakumar as inventors. An advertising program may include information concerning accounts, campaigns, creatives, targeting, etc. The term “account” relates to information for a given advertiser (e.g., a unique e-mail address, a password, billing information, etc.). A “campaign” or “ad campaign” refers to one or more groups of one or more advertisements, and may include a start date, an end date, budget information, geo-targeting information, syndication information, etc. For example, Honda may have one advertising campaign for its automotive line, and a separate advertising campaign for its motorcycle line. The campaign for its automotive line may have one or more ad groups, each containing one or more ads. Each ad group may include targeting information (e.g., a set of keywords, a set of one or more topics, geolocation information, user profile information, etc.), and price information (e.g., a maximum cost or offer per selection, a maximum cost or offer per conversion, a cost or offer per selection, a cost or offer per conversion, etc.). Alternatively, or in addition, each ad group may include an average cost (e.g., average cost per selection, average cost per conversion, etc.). Therefore, a single maximum cost, cost, and/or a single average cost may be associated with one or more keywords, and/or topics. As stated, each ad group may have one or more ads or “creatives” (That is, ad content that is ultimately rendered to an end user.). Each ad may also include a link to a URL (e.g., a landing Web page, such as the home page of an advertiser, or a Web page associated with a particular product or service). Naturally, the ad information may include more or less information, and may be organized in a number of different ways.

FIG. 2 illustrates an environment 200 in which the present invention may be used. A user device (also referred to as a “client” or “client device”) 250 may include a browser facility (such as the Explorer browser from Microsoft, the Opera Web Browser from Opera Software of Norway, the Navigator browser from AOL/Time Warner, etc.), some other content rendering facility, an e-mail facility (e.g., Outlook from Microsoft), etc. A search engine 220 may permit user devices 250 to search collections of documents (e.g., Web pages). A content server 210 may permit user devices 250 to access documents. An e-mail server (such as Hotmail from Microsoft Network, Yahoo Mail, etc.) 240 may be used to provide e-mail functionality to user devices 250. An ad server 210 may be used to serve ads to user devices 250. For example, the ads may be served in association with search results provided by the search engine 220. Alternatively, or in addition, content-relevant ads may be served in association with content provided by the content server 230, and/or e-mail supported by the e-mail server 240 and/or user device e-mail facilities.

As discussed in U.S. patent application Ser. No. 10/375,900 (introduced above), ads may be targeted to documents served by content servers. Thus, one example of an ad consumer 130 is a general content server 230 that receives requests for documents (e.g., articles, discussion threads, music, video, graphics, search results, Web page listings, etc.), and retrieves the requested document in response to, or otherwise services, the request. The content server may submit a request for ads to the ad server 120/210. Such an ad request may include a number of ads desired. The ad request may also include document request information. This information may include the document itself (e.g., a Web page), a category or topic corresponding to the content of the document or the document request (e.g., arts, business, computers, arts-movies, arts-music, etc.), part or all of the document request, content age, content type (e.g., text, graphics, video, audio, mixed media, etc.), geo-location information, document information, etc.

The content server 230 may combine the requested document with one or more of the advertisements provided by the ad server 120/210. This combined information including the document content and advertisement(s) is then forwarded towards the end user device 250 that requested the document, for presentation to the user. Finally, the content server 230 may transmit information about the ads and how, when, and/or where the ads are to be rendered (e.g., position, selection or not, impression time, impression date, size, conversion or not, etc.) back to the ad server 120/210. Alternatively, or in addition, such information may be provided back to the ad server 120/210 by some other means.

Another example of an ad consumer 130 is the search engine 220. A search engine 220 may receive queries for search results. In response, the search engine may retrieve relevant search results (e.g., from an index of Web pages). An exemplary search engine is described in the article S. Brin and L. Page, “The Anatomy of a Large-Scale Hypertextual Search Engine,” Seventh International World Wide Web Conference, Brisbane, Australia and in U.S. Pat. No. 6,285,999 (both incorporated herein by reference). Such search results may include, for example, lists of Web page titles, snippets of text extracted from those Web pages, and hypertext links to those Web pages, and may be grouped into a predetermined number of (e.g., ten) search results.

The search engine 220 may submit a request for ads to the ad server 120/210. The request may include a number of ads desired. This number may depend on the search results, the amount of screen or page space occupied by the search results, the size and shape of the ads, etc. In one embodiment, the number of desired ads will be from one to ten, and preferably from three to five. The request for ads may also include the query (as entered or parsed), information based on the query (such as geolocation information, whether the query came from an affiliate and an identifier of such an affiliate, and/or as described below, information related to, and/or derived from, the search query), and/or information associated with, or based on, the search results. Such information may include, for example, identifiers related to the search results (e.g., document identifiers or “docIDs”), scores related to the search results (e.g., information retrieval (“IR”) scores such as dot products of feature vectors corresponding to a query and a document, Page Rank scores, and/or combinations of IR scores and Page Rank scores), snippets of text extracted from identified documents (e.g., Web pages), full text of identified documents, topics of identified documents, feature vectors of identified documents, etc.

The search engine 220 may combine the search results with one or more of the advertisements provided by the ad server 120/210. This combined information including the search results and advertisement(s) is then forwarded towards the user that submitted the search, for presentation to the user. Preferably, the search results are maintained as distinct from the ads, so as not to confuse the user between paid advertisements and presumably neutral search results.

Finally, the search engine 220 may transmit information about the ad and when, where, and/or how the ad was to be rendered (e.g., position, click-through or not, impression time, impression date, size, conversion or not, etc.) back to the ad server 120/210. As described below, such information may include information for determining on what basis the ad way determined relevant (e.g., strict or relaxed match, or exact, phrase, or broad match, etc.) Alternatively, or in addition, such information may be provided back to the ad server 120/210 by some other means.

Finally, the e-mail server 240 may be thought of, generally, as a content server in which a document served is simply an e-mail. Further, e-mail applications (such as Microsoft Outlook for example) may be used to send and/or receive e-mail. Therefore, an e-mail server 240 or application may be thought of as an ad consumer 130. Thus, e-mails may be thought of as documents, and targeted ads may be served in association with such documents. For example, one or more ads may be served in, under over, or otherwise in association with an e-mail.

Although the foregoing examples described servers as (i) requesting ads, and (ii) combining them with content, one or both of these operations may be performed by a client device (such as an end user computer for example).

§ 4.1.1 Definitions

Online ads may have various intrinsic features. Such features may be specified by an application and/or an advertiser. These features are referred to as “ad features” below. For example, in the case of a text ad, ad features may include a title line, ad text, and an embedded link. In the case of an image ad, ad features may include images, executable code, and an embedded link. Depending on the type of online ad, ad features may include one or more of the following: text, a link, an audio file, a video file, an image file, executable code, embedded information, etc.

When an online ad is served, one or more parameters may be used to describe how, when, and/or where the ad was served. These parameters are referred to as “serving parameters” below. Serving parameters may include, for example, one or more of the following: features of (including information on) a document on which, or with which, the ad was served, a search query or search results associated with the serving of the ad, a user characteristic (e.g., their geographic location, the language used by the user, the type of browser used, previous page views, previous behavior, user account, any Web cookies used by the system, etc.), a host or affiliate site (e.g., America Online, Google, Yahoo) that initiated the request, an absolute position of the ad on the page on which it was served, a position (spatial or temporal) of the ad relative to other ads served, an absolute size of the ad, a size of the ad relative to other ads, a color of the ad, a number of other ads served, types of other ads served, time of day served, time of week served, time of year served, etc. Naturally, there are other serving parameters that may be used in the context of the invention.

Although serving parameters may be extrinsic to ad features, they may be associated with an ad as serving conditions or constraints. When used as serving conditions or constraints, such serving parameters are referred to simply as “serving constraints” (or “targeting criteria”). For example, in some systems, an advertiser may be able to target the serving of its ad by specifying that it is only to be served on weekdays, no lower than a certain position, only to users in a certain location, etc. As another example, in some systems, an advertiser may specify that its ad is to be served only if a page or search query includes certain keywords or phrases. As yet another example, in some systems, an advertiser may specify that its ad is to be served only if a document being served includes certain topics or concepts, or falls under a particular cluster or clusters, or some other classification or classifications.

“Ad information” may include any combination of ad features, ad serving constraints, information derivable from ad features or ad serving constraints (referred to as “ad derived information”), and/or information related to the ad (referred to as “ad related information”), as well as an extension of such information (e.g., information derived from ad related information).

The ratio of the number of selections (e.g., clickthroughs) of an ad to the number of impressions of the ad (i.e., the number of times an ad is rendered) is defined as the “selection rate” (or “clickthrough rate”) of the ad.

A “conversion” is said to occur when a user consummates a transaction related to a previously served ad. What constitutes a conversion may vary from case to case and can be determined in a variety of ways. For example, it may be the case that a conversion occurs when a user clicks on an ad, is referred to the advertiser's Web page, and consummates a purchase there before leaving that Web page. Alternatively, a conversion may be defined as a user being shown an ad, and making a purchase on the advertiser's Web page within a predetermined time (e.g., seven days). In yet another alternative, a conversion may be defined by an advertiser to be any measurable/observable user action such as, for example, downloading a white paper, navigating to at least a given depth of a Website, viewing at least a certain number of Web pages, spending at least a predetermined amount of time on a Website or Web page, registering on a Website, etc. Often, if user actions don't indicate a consummated purchase, they may indicate a sales lead, although user actions constituting a conversion are not limited to this. Indeed, many other definitions of what constitutes a conversion are possible.

The ratio of the number of conversions to the number of impressions of the ad (i.e., the number of times an ad is rendered) is referred to as the “conversion rate.” If a conversion is defined to be able to occur within a predetermined time since the serving of an ad, one possible definition of the conversion rate might only consider ads that have been served more than the predetermined time in the past.

A “document” is to be broadly interpreted to include any machine-readable and machine-storable work product. A document may be a file, a combination of files, one or more files with embedded links to other files, etc. The files may be of any type, such as text, audio, image, video, etc. Parts of a document to be rendered to an end user can be thought of as “content” of the document. A document may include “structured data” containing both content (words, pictures, etc.) and some indication of the meaning of that content (for example, e-mail fields and associated data, HTML tags and associated data, etc.) Ad spots in the document may be defined by embedded information or instructions. In the context of the Internet, a common document is a Web page. Web pages often include content and may include embedded information (such as meta information, hyperlinks, etc.) and/or embedded instructions (such as JavaScript, etc.). In many cases, a document has a unique, addressable, storage location and can therefore be uniquely identified by this addressable location. A universal resource locator (URL) is a unique address used to access information on the Internet.

“Document information” may include any information included in the document, information derivable from information included in the document (referred to as “document derived information”), and/or information related to the document (referred to as “document related information”), as well as an extensions of such information (e.g., information derived from related information). An example of document derived information is a classification based on textual content of a document. Examples of document related information include document information from other documents with links to the instant document, as well as document information from other documents to which the instant document links.

Content from a document may be rendered on a “content rendering application or device”. Examples of content rendering applications include an Internet browser (e.g., Explorer or Netscape), a media player (e.g., an MP3 player, a Realnetworks streaming audio file player, etc.), a viewer (e.g., an Abobe Acrobat pdf reader), etc.

A “content owner” is a person or entity that has some property right in the content of a document. A content owner may be an author of the content. In addition, or alternatively, a content owner may have rights to reproduce the content, rights to prepare derivative works of the content, rights to display or perform the content publicly, and/or other proscribed rights in the content. Although a content server might be a content owner in the content of the documents it serves, this is not necessary.

“User information” may include user behavior information and/or user profile information.

“E-mail information” may include any information included in an e-mail (also referred to as “internal e-mail information”), information derivable from information included in the e-mail and/or information related to the e-mail, as well as extensions of such information (e.g., information derived from related information). An example of information derived from e-mail information is information extracted or otherwise derived from search results returned in response to a search query composed of terms extracted from an e-mail subject line. Examples of information related to e-mail information include e-mail information about one or more other e-mails sent by the same sender of a given e-mail, or user information about an e-mail recipient. Information derived from or related to e-mail information may be referred to as “external e-mail information.”

“Ad area” may be used to describe an area (e.g., spatial and/or temporal) of a document reserved or made available to accommodate the rendering of ads. For example, Web pages often allocate a number of spots where ads can be rendered, referred to as “ad spots”. As another example, an audio program may allocate “ad time slots”.

§ 4.2 Exemplary Embodiments

The present invention may be used to help serve ads having different treatments and/or characteristics, such as text ads and image ads for example. The present invention may do so using various techniques, described below. As will be appreciated by those skilled in the art, at least some of these techniques may be used alone, or in combination.

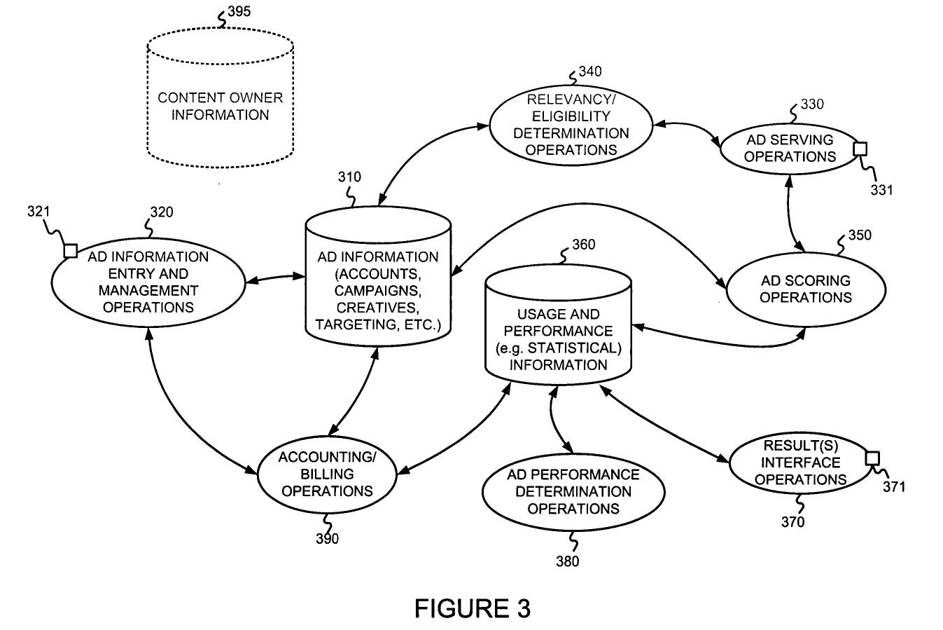

FIG. 3 is a bubble diagram illustrating an exemplary ad system 300 (Recall, e.g., 120 of FIG. 1 and 210 of FIG. 2.), consistent with the present invention. Various aspects of the present invention may operate in or with such a system 300. The exemplary ad system 300 may store ad information 310 and usage and/or performance (e.g., statistical) information 360. The exemplary system 300 may support ad information entry and management operations 320, ad serving operations 330, relevancy and/or eligibility determination operations 340, ad scoring operations 350, results interface operations 270, ad performance determination operations 380, and accounting and billing operations 390.

Advertisers 110 may interface with the system 300 via the ad information entry and management operations 320 as indicated by interface 321. Ad consumers 130 may interface with the system 300 via the ad serving operations 330 as indicated by interface 331. Ad consumers 130 or other entities (not shown) may also interface with the system 300′ via results interface operations 370 as indicated by interface 371.

An advertising program may include information concerning accounts, campaigns, creatives, targeting, etc. The term “account” relates to information for a given advertiser (e.g., a unique email address, a password, billing information, etc.). A “campaign” or “ad campaign” refers to one or more groups of one or more advertisements, and may include a start date, an end date, budget information, geo-targeting information, syndication information, etc. For example, Honda may have one advertising campaign for its automotive line, and a separate advertising campaign for its motorcycle line. The campaign for its automotive line has one or more ad groups, each containing one or more ads. Each ad group may include a set of keywords, and an offer (e.g., maximum cost per selection, maximum cost per conversion, average cost per selection, average cost per conversion, etc.). As stated, each ad group may have one or more ads or “creatives” (That is, ad content that is ultimately rendered to an end user.). One or more of the creatives may be text creatives, and one or more of the creatives may be image creatives.

The ad information 310 can be entered and managed via the ad information entry and management operation(s) 310. Campaign (e.g., targeting) assistance operations (not shown) can be employed to help advertisers 110 generate effective ad campaigns. The ad serving operations 330 may service requests for ads from ad consumers 130. The ad serving operations 330 may use relevancy/eligibility determination operations 340 to determine candidate ads for a given request. Such operations 340 may be used to provide more useful ads. Ad scoring operations 350 may use ad information and/or ad performance information 360 to score ads. (See, e.g., U.S. patent application Ser. No. 10/112,654 (incorporated herein by reference and referred to as “the '654 application”)), titled “METHODS AND APPARATUS FOR ORDERING ADVERTISEMENTS BASED ON PERFORMACE INFORMATION AND PRICE INFORMATION”, filed on Mar. 29, 2002 and listing Salar Arta Kamangar et al as inventors; and U.S. patent application Ser. No. 10/112,656 (incorporated herein by reference and referred to as “the '656 application”), titled “METHODS AND APPARATUS FOR ORDERING ADVERTISEMENTS BASED ON PERFORMANCE INFORMATION”, filed on Mar. 29, 2002 and listing Georges Harik et al as inventors.) The ad serving operations 330 may assign attributes (e.g., placement, enhanced features, etc., also referred to collectively as “treatments”) to ads using the scores. (The scores of ads may be used for many different purposes, some of which include ranking ads, prioritizing ads, assigning features to ads, filtering ads, etc.) The result(s) interface operations 370 may be used to accept result information (from the ad consumers 130 or some other entity) about an ad actually served, such as whether or not a selection occurred, whether or not a conversion occurred, etc. Such result(s) information may be accepted at interface 371 and may include information to identify the ad and time the ad was served, as well as the associated result. Ad performance determination operations 380 may be used to generate performance information for ads (e.g., either individually, or across some collection of ads, such as all ads, all keyword targeted ads, all content targeted ads, all ads served on a particular Website or document, etc.). Ad performance information may be inferred or estimated. Accounting/billing operations 390 may be used to bill advertisers. Finally, the system 300 may also include or use content-owner information 395. Such information may include content-owner preferences, restrictions and/or requirements. Such information 395′ may be used by ad serving operations 330, relevancy/eligibility operations 340, and/or ad scoring operation 350 for example. Specifically, such information 395 may be used to help accommodate the wishes of content owners. Some examples of content owner requirements may be (a) text ads only, (b) image ads only, (c) text or image ads in any order, (d) text or image ads but consecutive, (e) text or image ads but consecutive, with text ads before image ads, (f) text or image ads but consecutive, with image ads before text ads, etc. Alternatively, content owner information may be included in a request received by the ad serving operations 330.

Embodiments consistent with the present invention may be used to determine which ads to serve. Such a determination may consider, for example, one or more of (i) the relevancy of ads to an inferred user interest (e.g., inferred from a search query, document content, etc.), (ii) how best to utilize (e.g., best monetize) the ad area available to ads, (iii) content owner preferences and/or requirements, (iv) advertiser preferences and/or requirements, (v) fairness to competing ads or competing advertisers, (vii) implementation simplicity, (viii) computer storage resources, (ix) computer processing resources, etc.

Embodiments consistent with the present invention may be used to help determine costs to be billed to advertisers. Such a determination may consider, for example, one or more of (i) how best to obtain an advertiser's value of serving its ad, (ii) fairness to competing ads or competing advertisers, (iii) ad management simplicity, (iv) implementation simplicity, etc.

§ 4.2.1 Exemplary Data Structures

Recall from FIG. 3 that various stored information may be used by various operations. The following describes exemplary data structures that may be used to store such information in ways consistent with the present invention. Other data structures, which may include more or less information, or similar information in different forms, may be used.

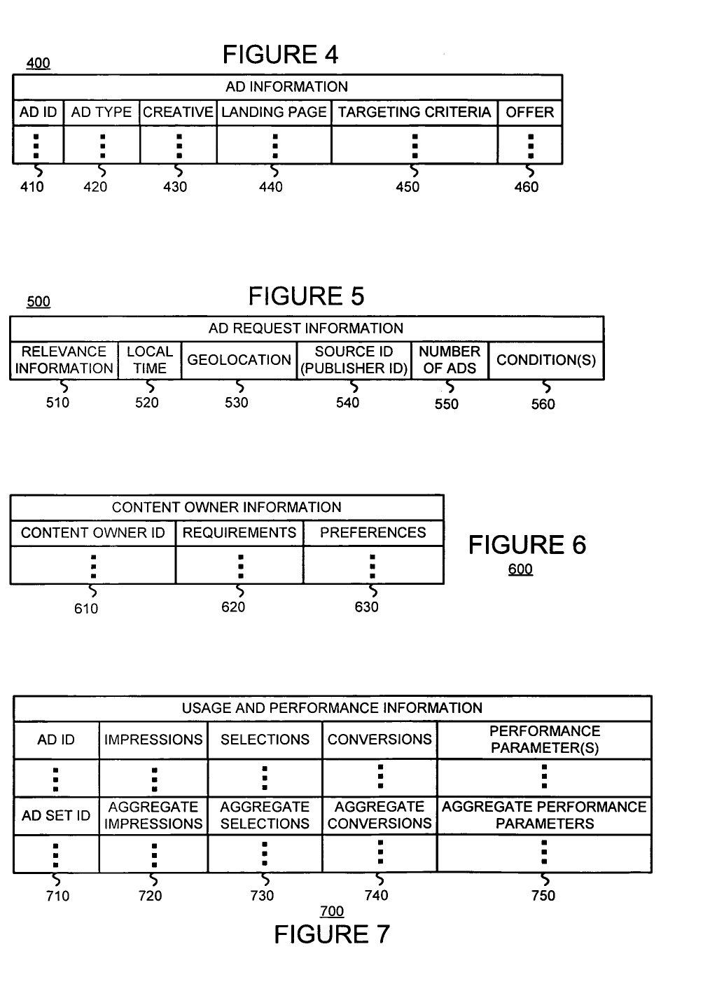

FIG. 4 is an exemplary table 400 that may be used to store ad information 310 in a manner consistent with the present invention. The table 400 may include a number of entries, each of which entries may include one or more of an ad identifier 410, an ad type 420, an ad creative (or a pointer to an ad creative) 430, a landing page (or some other selection responsive action) 440, one or more targeting criteria 450, and one or more offers 460. The ad identifier 410 may be used to uniquely identify an ad. The ad type 420 may be used to differentiate different types of ads, such as text ads from image ads, large image ads from small image ads, video ads from image and text ads, etc. The creative (or a pointer to the creative) 430 may define what is to be rendered on the user device to which the ad is served. The landing page 440 may define a document (e.g., a Web page) to be loaded into (e.g., a browser of) the user device upon selection of the ad. The targeting criteria 450 may include one or more of targeting keywords, targeting concepts or topics, geotargeting, local time targeting, day, date, day or week month, season targeting, etc. The offer 460 may include, for example, a maximum offer for a desired action (e.g., selection, conversion, etc.), an offer for a desired action, etc. One or more offers 460 may be associated with one or more targeting criteria 450 for example.

FIG. 5 is an exemplary message 500 that may be used to store ad request information. The message 500 may include one or more of relevance information 510, local time information 520, geolocation information 530, a source identifier 540, a number of ads desired 550, and one or more conditions 560. The relevance information 510 may include, for example, keywords extracted from a search query. Alternatively, the relevance information 510 may include topics or concepts about a document (or information from which such topics or concepts can be determined or derived) with which the ads will be rendered. The local time information 520 may include the local time of the user device on which the requested ad(s) will be rendered. The geolocation information 530 may include location information about the user device on which the requested ad(s) will be rendered. The source identifier 540 may be used to identify a content owner (e.g., a Web publisher) of a document with which the requested ad(s) will be rendered. Alternatively, the source identifier 540 may be used to identify a syndication partner of the ad server. The number of ads 550 may specify the number of ads desired, or the maximum number of ads permitted. The conditions 560 may include eligibility conditions such as, for example, text ads only, image ads only, no ads including certain terms or phrases or related to certain topics, no non-targeted ads, etc.

FIG. 6 is an exemplary table 600 that may be used to store content owner information 395 in a manner consistent with the present invention. The table 600 may include a number of entries, each of which entries may include one or more of a content owner identifier 610, requirements 620 and preferences 630. The requirements 620 and/or preferences 630 may be similar to the conditions 560 of the message 500 of FIG. 5 described above. Note that if the message 500 includes content owner requirements and/or preferences as conditions, such information need not be stored separately.

FIG. 7 is an exemplary table 700 that may be used to store usage and performance information 360 in a manner consistent with the present invention. The table 700 may include a number of entries, each of which entries may include one or more of an ad identifier or ad set identifier 710, impressions for an ad or aggregate impressions for a set 720, selections for an ad or aggregate impressions for a set 730, conversions for an ad or aggregate conversions for a set 740, and one or more performance parameters for an ad or aggregate performance parameters for the set 750. Performance parameters may include one or more of selection rate, conversion rate, etc. The aggregated performance parameters may include one or more of selection rate of a particular ad type (e.g., text ads, image ads, etc.), conversion rate of a particular ad type, selection rate of a set of similar ads (e.g., ads with common targeting criteria), conversion rate of a set of similar ads, selection rate for a given document (e.g., Web page) or set of documents (e.g., a Website, documents concerning a certain topic or concept, etc.), conversion rate for a given document or set of documents, etc. At least some performance parameters may be determined (or updated) as needed from the usage information. At least some performance parameters may be adjusted (e.g., normalized) to remove the influence of various factors (e.g., ad position, documents on which the ad was served, etc.). At least some performance parameters may be estimated. (See, e.g., U.S. patent application Ser. No. 10/350,910 (incorporated herein by reference), titled “ESTIMATING USER BEHAVIOR AND USING SUCH ESTIMATES, filed on Jan. 24, 2004 and listing Eric Veach as the inventor.)

Having introduced exemplary data structures for storing information in a manner consistent with the present invention, exemplary methods that may be used to perform various operations in a manner consistent with the present invention are described in § 4.2.2 below.

§ 4.2.2 Exemplary Methods

As introduced above, embodiments consistent with the present invention may be used to determine which ads to serve. Such a determination may consider, for example, one or more of (i) the relevancy of ads to an inferred user interest (e.g., inferred from a search query, document content, etc.), (ii) how best to utilize (e.g., best monetize) the ad area available to ads, (iii) content owner preferences and/or requirements, (iv) advertiser preferences and/or requirements, (v) fairness to competing ads or competing advertisers, (vii) implementation simplicity, (viii) computer storage resources, (ix) computer processing resources, etc. Exemplary methods that may be used to determine which ads to serve, in a manner consistent with the present invention, are described in § 4.2.2.1 below.

Embodiments consistent with the present invention may be used to help determine costs to be billed to advertisers. Such a determination may consider, for example, one or more of (i) how best to elicit an advertiser's value of serving its ad, (ii) fairness to competing ads or competing advertisers, (iii) ad management simplicity, (iv) implementation simplicity, etc. Exemplary methods that may be used to help determine costs to be billed to advertisers, in a manner consistent with the present invention, are described in § 4.2.2.2 below.

§ 4.2.2.1 Exemplary Methods for Determining Ads to be Served

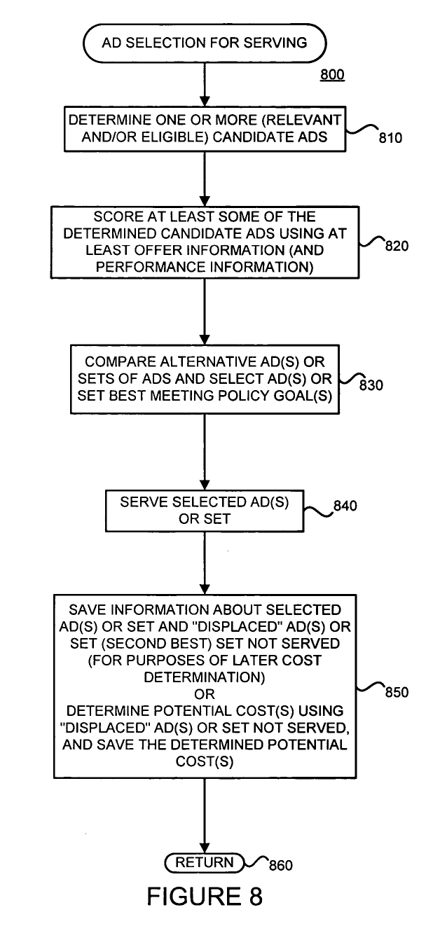

FIG. 8 is a flow diagram of an exemplary method 800 that may be used to select ads for serving in a manner consistent with the present invention. One or more (e.g., relevant and/or eligible) candidate ads are determined. (Block 810) At least some of the determined candidate ads are scored using at least offer information (and perhaps performance information). (Block 820) Then, alternative ad(s) or sets of ads are compared and the ad(s) or set best meeting some policy goal is selected. (Block 830) The selected ad(s) or set of one or more ads is served (Block 840) and information that will be used when billing is saved (Block 850) before the method 800 is left (Node 860). Referring to block 850, potential cost(s) can be determined using information from ad(s) not served or ads of the displaced set of ads not served, and such potential costs can be stored. Alternatively, such information from ad(s) not served or ads of the displaced set of ads not served can be saved for purposes of cost(s) determination later, as needed.

Referring back to block 810, the candidate ads determined may be relevant and/or eligible. Relevancy of an ad may be determined by comparing targeting criteria of the ad to corresponding information in the ad request (and/or information derived from or found with information in the ad request). Eligibility of an ad may be determined by comparing ad information with content owner requirements (e.g., no image ads, no text ads, etc.). Like relevancy, eligibility of an ad may also be determined by comparing targeting criteria of the ad to corresponding information in the ad request (and/or information derived from or found with information in the ad request). In at least some embodiments consistent with the present invention, ads can become ineligible if their global performance (e.g., selection rate), or per Website or per document performance, is too low.

Referring back to block 820, at least some of the candidate ads may be scored using at least offer information and performance information. For example, a revenue-based score may be determined by multiplying an ad's selection rate by its offer (e.g., maximum price) per selection. (See, e.g., the '654 application.)

Referring back to block 830, alternative ad(s) or sets of ads are compared and ad(s) or a set that best meets some policy goal is selected. In some cases, such as when the ads are all of the same type and each occupy the same amount of “ad area”, this selection may be as simple as selecting the highest scoring ads until no more ads can fit into the ad area or until a maximum number of permitted ads is reached. However, depending on the policy goal to be met, as well as any additional constraints to be followed, this selection can become more complicated. Further, if different types of ads, each of which take up different amounts of “ad area”, such as text ads and image ads for example, are to be considered, this selection can become more complicated. Note that it is possible for a set of ads occupying less “ad area” to have a higher expected value than one occupying more “ad area”.

A number of alternative ways for comparing and selecting the best ad(s) or set of ads are described here. The present invention is not limited to the particular examples described.

### EXAMPLE 1

Assume that image ads and text ads can be served, and that four text ads can be served in the place of one image ad. Further assume that the image ads (m1, m2, m3, m4 . . . ) and the text ads (t1, t2, t3, t4, . . . ) are candidates and are ordered from highest to lowest scoring. Finally, assume that the ad area can only accommodate one image ad or four text ads.

In one example consistent with the present invention, the image ad m1 is rendered if and only if:
MaxCPM(m1)>(MaxCPM(t1)+MaxCPM(t2)+MaxCPM(t3)+MaxCPM(t4))
where MaxCPM is the product of a selection (click through) rate of the ad (sometimes referred to as CTR), and a cost per selection (e.g., maximum) offer (sometimes referred to as CPC) associated with the ad. Note that if the selection rate of the image ad is not known, it can be estimated. MaxCPMExpected values other than MaxCPM may be used instead.

This determination is relatively straight forward if there is (statistically significant) performance data available. For some systems that have served one type of ad (e.g., text only ads) but not another type of ad (e.g., image ads), one challenge is that there might not be (statistically significant) performance data available for image ads. Thus, a CTR for the image ads has to be determined inferentially, in order to determine MaxCPM values for the image ads. There are several variations of how this may be done. In each variation, it is assumed that MaxCPM(ad)=CTR(ad)*CPC(ad).

In a first variation, CTR(mᵢ)=CTR(tᵢ)*c. Thus, MaxCPM(mᵢ)=(CTR(tᵢ)*c)*CPC(mᵢ), where c is a constant (e.g., 5), and tᵢ and mᵢ are “related” ads. In this first variation, it is assumed the selection rate of the image ad (CTR(mᵢ) can be approximated as the selection rate of the “related” text ad (CTR(tᵢ)) multiplied by a constant c. For example, setting c to 5 assumes that an associated image ad (mᵢ) will have 5 times the selection rate as that of the “related” text ad (tᵢ). The image ad mᵢ may be related with the text ad tᵢ in a number of ways. For example, these ads may belong to the same ad group of the same ad campaign. Note, however, that if a text ad and an image ad are in the same ad group of the same ad campaign for the same advertiser, the related text ad may be dropped from the comparison. It may be desirable to force an advertiser to always have a text ad in the same group as each image ad so that such inferences can be made. That is, if the normal case is comparing:
MaxCPM(m1) with (MaxCPM(t1)+MaxCPM(t2)+MaxCPM(t3)+MaxCPM(t4)),
but t1 and m1 belong to the same ad group of the same ad campaign, then MaxCPM(m1) is compared with (MaxCPM(t2)+MaxCPM(t3)+MaxCPM(t4)+MaxCPM(t5)). This avoids having an advertiser's text ad competing with their image ad.

Rather than set c to a predetermined value, c can be calculated as a ratio of an aggregate selection rate of all image ads of an (e.g., content relevant) ad server (CTR(mₐₗₗ)) to the aggregate selection rate of all text ads (CTR(tₐₗₗ)) on the same ad server or on a different (e.g., keyword relevant) ad server. That is, rather than using some constant which may be static and which may merely be based on a hunch or on conditions that have changed, the value of c can be updated, and can have some basis in actual performance information collected. Thus, in this case, c=CTR(all image ads)/CTR(all text ads).

As a slight variant, instead of determining c using aggregate selection rate information for all image ads and for all text ads, c can be determined as a ratio of the selection rate of a particular collection of image ads (CTR(m_{collection})) (e.g., on a content relevant ad server) to the selection rate of a related collection of text ads (CTR(t_{collection})) (e.g., on a keyword relevant ad server). Related ad collections can be defined in a number of ways. For example, an ad collection may be defined as a collection of ads—both image ads and text ads—that share the same targeting keywords. Such a collection may be useful since image ads and text ads will only be competing for space on an ad area if they both have targeting criteria that are met by the ad request. Thus, in this case, c=CTR(all image ads in the ad collection)/CTR(all text ads in the ad collection). This variant provides a more accurate model of how well an image ad performs compared to other image ads.

Assuming that (statistically significant) performance information is available for the image ad, the following expression may be used MaxCPM(mᵢ)=CTR(mᵢ)*CPC(mᵢ). At this point, the constant C is not needed, and therefore a ratio including performance information from a related text ad, or a set text ads belonging to a same group, all text ads need not be determined.

Performance parameters, such as performance parameters estimated using any of the techniques just described, may be adjusted (e.g., normalized) to remove external influences. For example, suppose ads of a first type are rendered on a search results Web page, while ads of another type are rendered on various different content Web pages. The relative performance of the ads rendered on the search results Web page should not be influenced by the page on which they were rendered (assuming that the format of the search results Web page doesn't change too much). On the other hand, the performance of ads rendered on various Web pages (as targeted by the content of those Web pages) may be influenced by the Web page(s) on which they were rendered. Thus, in yet another variant, the potential value of an image ad may be expressed as follows:
MaxCPM(mᵢ)=CTR_{normalized}(mᵢ)*CPC(mᵢ).

This accounts for the fact that the impressions for image ad (mᵢ) may span many different Websites that all have different variables that affect the serving of the ad. For example, if the image ad is placed at the top of a Webpage, such placement may induce a higher selection rate (CTR) than if the image ad were placed on the bottom of a Web page. So if some Websites display ads at their tops, while other Websites display ads at their bottoms, this can have a great influence on the performance of the ads. This makes it hard to compare the performance of two image ads (m1 and m2) to each other since they might have different impressions on different types of Webpages, each having different variables that affect the performance of the ads. To make this comparison fairer, the distribution of the image ads may be normalized. The influence of other factors affecting selection rate (or some other desired action), apart from the ad creative itself, may similarly be removed or minimized using normalization.

Estimating a performance parameter, such as selection rate for example, may consider other factors in addition to, or instead of historic information. For example, other attributes of the ad or the context in which the ad will be rendered may be considered (e.g., ad placement, number of competing ads placed with the ad, color of the ad, brand of the ad, etc.). Further, other techniques (e.g., Bayesian networks) for estimating a performance parameter may be used.

### EXAMPLE 2

Assume that image ads and text ads can be served, and that four text ads can be served in the place of one image ad. Further assume that the image ads (m1, m2, m3, m4 . . . ) and the text ads (t1, t2, t3, t4, . . . ) are candidates and are ordered from highest to lowest scoring. Finally, assume that the ad area can only accommodate one image ad or four text ads. Furthermore, assume that image ads are acceptable, but that either all image ads or all text ads are to be returned (as determined directly from the request or from content-owner information). In other words, image ads will be competing with text ads. Referring back to block 830, the act of comparing alternative sets of candidate ads and selecting a best set may be performed as follows. Text ads only are scored (e.g., using content CTR instead of search CTR). A sum of the MaxCPMs of the text ads is determined using the scores. Image ads are scored (MaxCPM) determined using the scores. If Sum of MaxCPM_text>MaxCPM_image, the set of text ads is selected. Otherwise, the image ad is selected. This can be expanded to the case where N image ads are competing against 4N text ads, and N>1.

§ 4.2.2.2 Exemplary Methods for Determining and/or Discounting Advertiser Costs

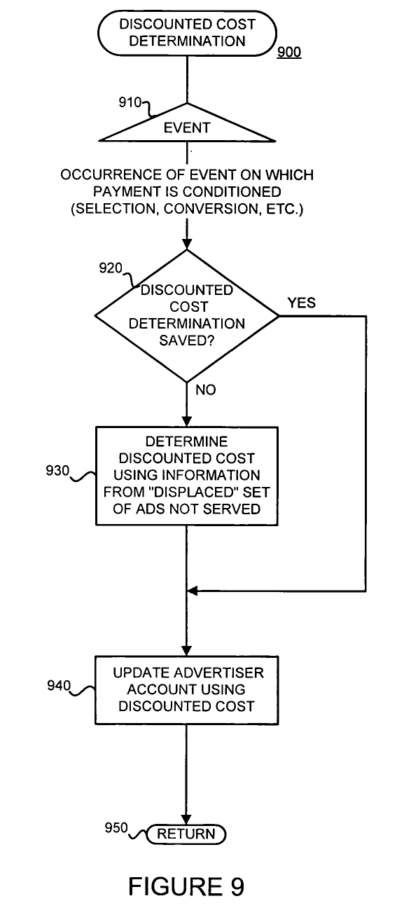

FIG. 9 is a flow diagram of an exemplary method 900 that may be used to determine discounted costs in a manner consistent with the present invention. The main acts of the method 900 are performed when an event (e.g., ad selection, conversion, etc.) upon which payment is conditioned occurs. (Block 910). Recall from block 850 of FIG. 8 that potential cost(s) may be determined and saved, or information from which costs can later be determined may be saved. Referring to the method 900, it is determined whether or not a discounted cost determination has been saved. (Block 920) If not, the discounted cost is determined using information of displaced ad(s) or of ads of the “displaced” set not served (Block 930) and the advertiser's account is updated using the discounted cost (Block 940) before the method 900 is left (Node 950). Referring back to block 920, if a discounted cost determination has been saved, the advertiser's account may be updated with the determined discounted cost (Block 940) before the method 900 is left (Node 950).

The determined cost to be billed may simply be an offer associated with an ad. Alternatively, the determined cost may be a function of one or more ads displaced, or a set of ads not served, as a consequence of serving the ad. (See, e.g., U.S. patent application Ser. No. 10,340,542 (incorporated herein by reference and referred to as “the '542 application”), titled “AUTOMATED PRICE MAINTENANCE FOR USE WITH A SYSTEM IN WHICH ADVERITISEMENTS ARE RENDERED WITH RELATIVE PREFERENCE BASED ON PERFORMACE INFORMATION AND PRICE INFORMAITON”, filed on Jan. 10, 2003 and listing Eric Veach et al as inventors; and U.S. patent application Ser. No. 10,340,543 (incorporated herein by reference and referred to as “the '543 application”), titled “AUTOMATED PRICE MAINTENANCE FOR USE WITH A SYSTEM IN WHICH ADVERITISEMENTS ARE RENDERED WITH RELATIVE PREFERENCES”, filed on Jan. 10, 2003 and listing Eric Veach et al as inventors. In at least some embodiments consistent with the present invention, a discounted cost is determined using a value of one or more ads displaced by its ad, or a set of ads not served. This value may be defined as the difference in (i) a value (e.g., estimated revenue) of serving a set of ads including the advertiser's ad and (ii) a value of the next most value (e.g., next highest amount of estimated revenue) set of ads, not including the advertiser's ad.

Other techniques for determining a cost may be used instead, and the present invention is not limited to embodiments in which a cost is discounted.

In some cases, such as when the ads are all of the same type and each occupy the same amount of “ad area”, the discounted cost determination may simply use the techniques described in the '542 and '543 applications. However, if different types of ads, each of which take up different amounts of “ad area”, are to be considered, discounted cost determination may be a bit more involved. A number of alternative ways for determining a discounted cost are described here. The present invention is not limited to the particular examples described.

### EXAMPLE

This example assumes that the offers are maximum offers (referred to as “CPC” without loss of generality) per selection (or click), and that the cost billed is discounted. This example also assumes that image ads and text ads compete for space in an ad area and that rendering an image ad will displace four (4) text ads.

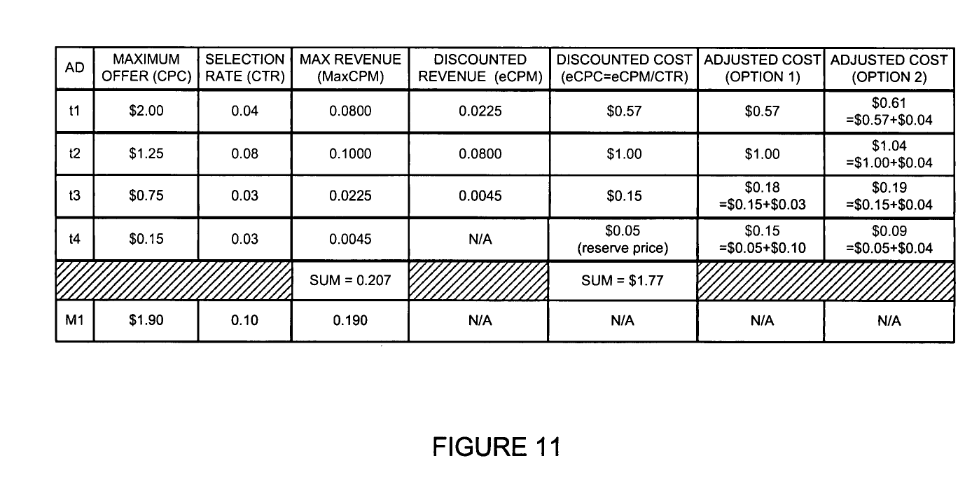

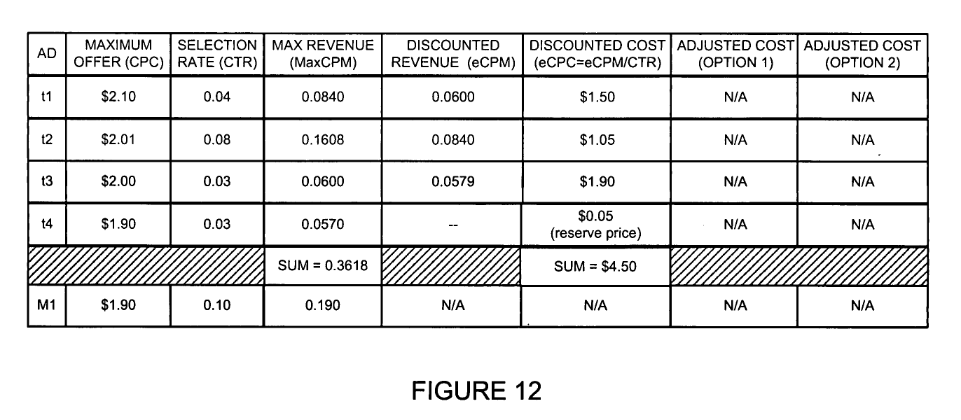

The final cost paid by the winning ad will be the expected value (e.g., MaxCPM) of any losing ads (i.e., any ads displaced by the winning ad) divided by the selection rate (CTR) of the winning ad. In the case where a set of text ads win over an image ad, there are two ways of apportioning the MaxCPM of the losing image ad among the plurality of winning text ads. Under the first option, the revised discounted cost for each text ad is determined by raising the discounted cost of the ads with less preferred treatments (e.g., in lower slots in the ad area) one by one, up to their maximums (CPCs), until the sum of the discounted costs of the text ads matches (or slightly exceeds, etc.) the cost that would have been charged to the image ad. The second option is to distribute (e.g., evenly or in accordance with some function and/or rules) the difference in costs among the winning text ads. Examples illustrating how these options may work are presented in § 4.3 below with reference to FIGS. 11 and 12.

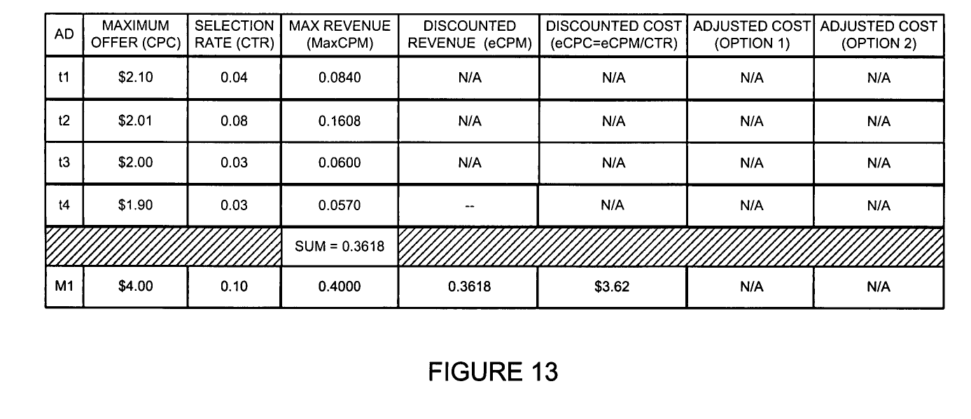

In the case where the image ad wins, it simply pays the sum of the expected values (e.g., MaxCPMs) of the text ads divided by the selection rate (CTR) of the image ad. An example of how this may work is presented in § 4.3 below with reference to FIG. 13. This logic is for the case where there is one image ad and N text ads. However, it can easily be extended to M image ads vs. N text ads. There is a special case in this arbitration that may make it desirable to adjust the foregoing techniques. Specifically, if a given advertiser has both a candidate image ad and a candidate text ad competing against one another, the ad will artificially drive each other's price up. For example, assume that there is only one AdGroup in the auction, but it has both a text ad and an image ad (both having the same maximum offer (CPC). In this scenario, the advertiser would end up paying MaxCPM of the text ad instead of a minimum offer (reserve price). These cases should be rare and may be treated as special cases, or avoided.

Finally, for the case where there are only image ads or only text ads competing, the auction may be treated as a simple arbitration (See, e.g., the '542 application.).

The foregoing techniques are advantageous in that they are simple to implement.

§ 4.2.3 Exemplary Apparatus

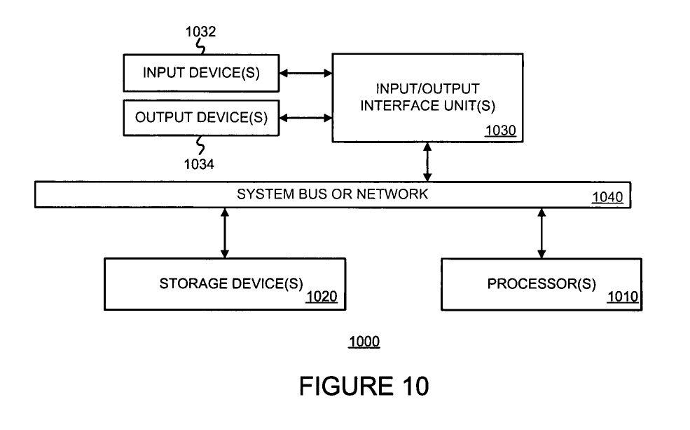

FIG. 10 is high-level block diagram of a machine 1000 that may perform one or more of the operations discussed above. The machine 1000 basically includes one or more processors 1010, one or more input/output interface units 1030, one or more storage devices 1020, and one or more system buses and/or networks 1040 for facilitating the communication of information among the coupled elements. One or more input devices 1032 and one or more output devices 1034 may be coupled with the one or more input/output interfaces 1030.

The one or more processors 1010 may execute machine-executable instructions (e.g., C or C++ running on the Solaris operating system available from Sun Microsystems Inc. of Palo Alto, Calif. or the Linux operating system widely available from a number of vendors such as Red Hat, Inc. of Durham, N.C.) to effect one or more aspects of the present invention. At least a portion of the machine executable instructions may be stored (temporarily or more permanently) on the one or more storage devices 1020 and/or may be received from an external source via one or more input interface units 1030.

In one embodiment, the machine 1000 may be one or more conventional personal computers. In this case, the processing units 1010 may be one or more microprocessors. The bus 1040 may include a system bus. The storage devices 1020 may include system memory, such as read only memory (ROM) and/or random access memory (RAM). The storage devices 1020 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 1032, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 1010 through an appropriate interface 1030 coupled to the system bus 1040. The output devices 1034 may include a monitor or other type of display device, which may also be connected to the system bus 1040 via an appropriate interface. In addition to (or instead of) the monitor, the personal computer may include other (peripheral) output devices (not shown), such as speakers and printers for example.

The various operations described above may be performed by one or more machines 1000, and the various information described above may be stored on one or more machines 1000. The ad server 210, search engine 220, content server 230, e-mail server 240, and/or user device 250 may include one or more machines 800.

§ 4.2.4 Alternatives and Extensions

In some of the examples above, the arbitration was described with respect to a policy goal of maximizing (or approximately maximizing) potential revenue (e.g., sum of selection rate*maximum offer per selection). Other policy goals are possible, and those skilled in the art can design arbitrations to meet such policy goods. For example, a policy goal might be to serve the advertiser's ad in a way desired by the advertiser, while containing, reducing, or minimizing costs, to render ads most having a maximum utility to users, etc. It is possible to have embodiments with different policy goals and different arbitrations consistent with the present invention.

In some of the examples above, the cost was determined as a discounted cost. It is possible to have embodiments which determine costs in other ways, including non-discounted costs, consistent with the present invention. Moreover, the determined cost to be billed to an advertiser may be subject to further adjustments such as advertiser discounts, special offer discounts, volume discounts, etc., or surcharges, such as minimum charges, late charges, etc.

Although some of the examples described above were applied to embodiments in which text ads and image ads could be served, the present invention is broadly applicable to ads of different types (e.g., flash ads, video ads, audio ads, etc.)

Although some of the examples described above were described in the context of determining whether or how to serve ads on a rendering instance of document (e.g., a page view), the present invention may also be used to make other determinations with respect to competing ads of different types, such as, for example, how frequently the ads are served, etc.

Although in some of the examples described above, the advertisers offered to pay a cost (e.g., a maximum cost) per selection, the present invention may be used with other offers such as an offer (e.g., a maximum cost offer) per conversion, an offer (e.g., a maximum cost offer) per impression, etc.

§ 4.3 Examples of Operations

Recall from § 4.2.2.2 above that in the case where a set of text ads win over an image ad, there are two ways of apportioning the expected value (e.g., MaxCPM) of the losing image ad among the plurality of winning text ads. Under the first option, the adjusted discounted cost for each text ad is determined by raising the discounted cost of the ads with less preferred treatments (e.g., in lower slots in the ad area) one by one, up to their maximums (CPCs), until the sum of the discounted costs of the text ads matches (or slightly exceeds, etc.) the cost that would have been charged to the image ad. The second option was to distribute the difference in costs among the winning text ads. Examples illustrating how these options may work are illustrated in FIGS. 11 and 12.

Referring first to FIG. 11, note that the sum of the MaxCPM of the ads (0.207) is greater than that of the image ad (0.190). An ad's discounted expected value (e.g., revenue) is set to that of the next lower ad (i.e., the displaced ad), and the discounted cost is set to the discounted revenue (eCPM) divided by the selection rate (CTR) of the ad. Since the sum of the discounted costs ($1.77) is less that what the image ad would have paid ($1.90), the difference ($0.13) can be apportioned to the discounted costs of the text ads in accordance with option 1 ($0.10 of the $0.13 apportioned to text ad t4 (up to its maximum $0.15), and the remaining $0.03 of the $0.13) apportioned to text ad t3, or option 2 ($0.04=$0.13/4, rounded up to the nearest cent, apportioned to each of the four text ads.

Referring to FIG. 12, since the sum of the discounted costs ($4.50) is already greater than what the image ad would have paid ($1.90), no further adjustments are made.

Recall that in the case where the image ad wins, it simply pays the sum of the expected values (e.g., MaxCPMs) of the text ads divided by the selection rate (CTR) of the image ad. As shown in FIG. 13, the cost is discounted from $4.00 to $3.62.

§ 4.4 Conclusions

As can be appreciated from the foregoing, an ad serving system for serving ads of different types, that may occupy different amounts of ad area of a document, is possible. The system is fair can be implemented using current technology. The system can be used to serve new types of ads even when (statistically significant) performance information is not available. The system can accommodate content owner (e.g., Web publisher) requirements.

1. A method comprising:
a) determining candidate ads to serve in response to an ad request, wherein the candidate ads include at least one ad of a first ad type and at least one ad of a second ad type;
b) determining a score of each of at least some of the candidate ads;
c) comparing alternative sets of the at least some of the candidate ads to select a set that best meets at least one policy goal; and
d) serving the selected set of candidate ads.

2. The method of claim 1 wherein the first ad type is a text ad and the second ad type is an image ad.

3. The method of claim 2 wherein the selected set of candidate ads is to be rendered on an ad area of a document, and
wherein ads of the first ad type occupy less ad area than ads of the second ad type.

4. The method of claim 3 wherein M ads of the first ad type can fit into an area occupied by N ads of the second ad type, and
wherein M>N.

5. The method of claim 1 wherein the at least one policy goal includes maximizing a potential estimated revenue associated with a set of ads to be served.

6. The method of claim 5 wherein each of the ads have an associated offer per user action and a user action rate.

7. The method of claim 6 wherein the estimated revenue associated with a set of ads includes a sum of potential estimated revenue for each ad of the set, and
wherein the potential estimated revenue for each ad includes a product of the offer per user action associated with the ad and the user action rate associated with the ad.

8. The method of claim 6 wherein the user action rate for ads of the second type is determined using the user action rate for ads of the first type.

9. The method of claim 8 wherein the user action rate for ads of the second type is determined using a product of the user action rate for ads of the first type and an adjustment factor.

10. The method of claim 9 wherein the adjustment factor is a ratio of an average user action rate for all ads of the second type to an average user action rate of all ads of the first type.

11. The method of claim 9 wherein the adjustment factor is a ratio of an average user action rate for a collection of ads of the second type to an average user action rate of a corresponding collection of ads of the first type.

12. The method of claim 9 wherein the adjustment factor is a ratio of a user action rate for an ad of the second type to a user action rate of a corresponding ad of the first type.

13. The method of claim 12 wherein the ad of the second type and the corresponding ad of the first type belong to the same ad group of the same ad campaign.

14. The method of claim 1 further comprising:
e) determining a discounted cost for at least one ad of the selected set of candidate ads using information from a set of candidate ads that meets the at least one policy goal second best.

15. The method of claim 1 wherein the selected set of candidate ads includes at least N image ads which displace at least M text ads in a non-selected set of candidate ads, wherein N is at least 1, wherein M>N, and wherein a potential expected revenue for serving the N image ads is greater than an expected potential revenue for serving the M text ads.

16. The method of claim 15 further comprising:
e) determining a discounted cost for the at least N image ads using information from the non-selected set of candidate ads.

17. The method of claim 16 further comprising:
f) adjusting the discounted cost using a difference between the expected value of the N image ads and the expected value of the M text ads.

18. The method of claim 18 wherein the act of adjusting distributes the difference across the at least N image ads.

19. The method of claim 1 wherein the selected set of candidate ads includes at least M text ads which displace at least N image ads in a non-selected set of candidate ads, wherein N is at least 1, wherein M>N, and wherein a potential expected revenue for serving the M text ads is greater than a potential expected revenue for serving the N image ads.

20. The method of claim 19 further comprising:
e) determining a cost for the at least M text ads using information from the non-selected set of candidate ads.

21. The method of claim 20 further comprising:
f) adjusting the discounted cost using a difference between the expected value of the M text ads and the expected value of the N image ads.

22. The method of claim 21 wherein the act of adjusting distributes the difference across the at least M text ads.

23. Apparatus comprising:
a) means for determining candidate ads to serve in response to an ad request, wherein the candidate ads include at least one ad of a first ad type and at least one ad of a second ad type;
b) means for determining a score of each of at least some of the candidate ads;
c) means for comparing alternative sets of the at least some of the candidate ads to select a set that best meets at least one policy goal; and
d) means for serving the selected set of candidate ads.

24. The apparatus of claim 23 wherein the first ad type is a text ad and the second ad type is an image ad.

25. The apparatus of claim 24 wherein the selected set of candidate ads is to be rendered on an ad area of a document, and
wherein ads of the first ad type occupy less ad area than ads of the second ad type.

26. The apparatus of claim 25 wherein M ads of the first ad type can fit into an area occupied by N ads of the second ad type, and
wherein M>N.

27. The apparatus of claim 23 wherein the at least one policy goal includes maximizing a potential estimated revenue associated with a set of ads to be served.

28. The apparatus of claim 27 wherein each of the ads have an associated offer per user action and a user action rate.

29. The apparatus of claim 28 wherein the estimated revenue associated with a set of ads includes a sum of potential estimated revenue for each ad of the set, and
wherein the potential estimated revenue for each ad includes a product of the offer per user action associated with the ad and the user action rate associated with the ad.

30. The apparatus of claim 28 further comprising means for determining the user action rate for ads of the second type using the user action rate for ads of the first type.

31. The apparatus of claim 30 wherein the means for determining the user action rate for ads of the second type use a product of the user action rate for ads of the first type and an adjustment factor.

32. The apparatus of claim 31 wherein the adjustment factor is a ratio of an average user action rate for all ads of the second type to an average user action rate of all ads of the first type.

33. The apparatus of claim 31 wherein the adjustment factor is a ratio of an average user action rate for a collection of ads of the second type to an average user action rate of a corresponding collection of ads of the first type.

34. The apparatus of claim 31 wherein the adjustment factor is a ratio of a user action rate for an ad of the second type to a user action rate of a corresponding ad of the first type.

35. The apparatus of claim 34 wherein the ad of the second type and the corresponding ad of the first type belong to the same ad group of the same ad campaign.

36. The apparatus of claim 23 further comprising:
e) means for determining a discounted cost for at least one ad of the selected set of candidate ads using information from a set of candidate ads that meets the at least one policy goal second best.

37. The apparatus of claim 23 wherein the selected set of candidate ads includes at least N image ads which displace at least M text ads in a non-selected set of candidate ads, wherein N is at least 1, wherein M>N, and wherein a potential expected revenue for serving the N image ads is greater than an expected potential revenue for serving the M text ads.

38. The apparatus of claim 37 further comprising:
e) means for determining a discounted cost for the at least N image ads using information from the non-selected set of candidate ads.

39. The apparatus of claim 38 further comprising:
f) means for adjusting the discounted cost using a difference between the expected value of the N image ads and the expected value of the M text ads.

40. The apparatus of claim 18 wherein the means for adjusting distribute the difference across the at least N image ads.

41. The apparatus of claim 23 wherein the selected set of candidate ads includes at least M text ads which displace at least N image ads in a non-selected set of candidate ads, wherein N is at least 1, wherein M>N, and wherein a potential expected revenue for serving the M text ads is greater than a potential expected revenue for serving the N image ads.

42. The apparatus of claim 41 further comprising:
e) means for determining a cost for the at least M text ads using information from the non-selected set of candidate ads.

43. The apparatus of claim 42 further comprising:
f) means for adjusting the discounted cost using a difference between the expected value of the M text ads and the expected value of the N image ads.

44. The apparatus of claim 43 wherein the means for adjusting distribute the difference across the at least M text ads.

45. A computer readable medium having stored thereon a computer readable message, the message comprising:
a) a request for at least one ad to be served with a document; and
b) document owner restrictions relating to a type of ad,
wherein types of ads include a text only ad, an image ad, an animation ad, a video ad, an interactive ad, and an audio ad.
